(19) United States
(12) Patent Application Publication
(10) Pub. No.: US 2004/0104807 A1
(43) Pub. Date: Jun. 3, 2004

(54) NETWORKED FINGERPRINT AUTHENTICATION SYSTEM AND METHOD

(75) Inventor: Frank Ko, Wellesley, MA (US)

Correspondence Address: FRANK KO, 73 CEDAR ST., WELLESLEY, MA, 02481, US

(73) Assignee: Frank Ko, Wellesley, MA (US)

(21) Appl. No.: 10/605,600

(22) Filed: Oct. 12, 2003

Related U.S. Application Data
(60) Provisional application No. 60/418,790, filed on Oct. 16, 2002.

(51) Int. Cl. G06F 7/04

(52) U.S. Cl. 340/5.83; 340/5.8; 713/186

(57) ABSTRACT

Disclosed are network fingerprint system and methods that eliminate the ratio requirement of one fingerprint sensor connected to one computer or equivalents thereof in processor and memory. The network fingerprint sensor system takes captured fingerprint image data, or fingerprint template data, and transmits the fingerprint data via TCP/IP or other network protocol to a centralized authentication server. The authentication server authenticates and verifies the received fingerprint data with an internal fingerprint database stored in the server. This implementation allows for one fingerprint authentication server to simultaneously control, optimize, obtain fingerprint data, analyze fingerprint data, authenticate, and verify fingerprint data from multiple network fingerprint sensors simultaneously.

### CROSS REFERENCE TO RELATED APPLICATIONS

This application claims the benefit of U.S. Provisional Patent Application No. 60/418,790, entitled NETWORKED FINGERPRINT AUTHENTICATION SYSTEM AND METHOD, filed Oct. 16, 2002, the entire disclosure of which is hereby incorporated by reference in its entirety.

### BACKGROUND OF INVENTION

1. Field of the Invention

The disclosed system and methods relate to multiple network fingerprint sensors and a network fingerprint sensor authentication system in which centralized fingerprint authentication servers can simultaneously control, optimize, obtain multiple fingerprint data for analysis, authenticate and verify fingerprints from multiple remote connected network fingerprint sensors via a TCP/IP network simultaneously.

2. Discussion of the Background

Conventional fingerprint authentication systems typically require a ratio of one fingerprint sensor or imaging apparatus connected to one computer (or its equivalent in processor and memory). In particular, fingerprint authentication systems are typically PC-based, and fingerprint sensor products are typically USB (Universal Serial Bus)-based, because they are designed to be connected directly to a PC. These PC-based fingerprint products rely on the computer's processing power to compare the fingerprint image (authentication/verification) data with a stored fingerprint template in the computer.

Network fingerprint authentication, in contrast, holds the promise of providing centralized fingerprint sensor control, centralized fingerprint sensor optimization, centralized fingerprint analysis, centralized fingerprint authentication and verification, monitoring, cross-referencing, database storage, while ultimately being most cost effective. However, true network fingerprint authentication has generally been cost prohibitive because of the multiple computers and other hardware required. For example, commercially available network fingerprint sensors typically include all of the following hardware:

a) a fingerprint sensor module connected to a personal computer that authenticates the fingerprint with the fingerprint template stored in the computer's storage medium. If there is a fingerprint match, the computer then allows for the person to access a computer network; or

b) a fingerprint sensor product is connected to a personal computer that receives a stored fingerprint template via a network. The personal computer then compares the fingerprint data with the fingerprint template stored in its storage medium. In these instances, fingerprint authentication is executed at the personal computer connected to the fingerprint sensor.

c) a fingerprint sensor product is connected to a personal computer. The computer controls, optimizes, and obtains the fingerprint image from the fingerprint sensor. The computer then sends the fingerprint image to a server for authentication result.

Similarly, standalone fingerprint sensor products such as for access control products (for doors, entrances, and the like) have semiconductor chips that have computer-like processing power. These chips are typically microprocessors, or digital signal processors (DSPs). They generally require additional memory chips to store the software used to process the fingerprint data for authentication/matching purposes. In addition, these standalone products use additional memory cards, or memory chips to store a limited database of fingerprint templates for authentication and verification. In these instances, fingerprint authentication is performed locally inside the standalone fingerprint sensor product.

Typically, in standalone fingerprint sensor products that claim network capability, such capability is limited to configuration and remote monitoring. Actual fingerprint control, optimization, analysis, authentication and verification are still performed locally, i.e., at the location where the fingerprint sensor product is located. Such products using local authentication at the sensor node also require the additional use of memory cards or proprietary network hardware. Still other standalone fingerprint products that claim network capability have only serial communications such as RS232 or RS485 in a daisy chain, and lack the full bandwidth that true network communication could offer.

It would be desirable to provide a true networked fingerprint sensing and authentication system, in which the ratio of one sensor to one computer could be avoided, and in which a single server could provide multiple fingerprint sensors control, multiple fingerprint sensors optimizations, multiple fingerprint data analysis, multiple fingerprint image capture, and multiple fingerprint authentication and verification of images or other data received from many fingerprint sensors simultaneously.

### SUMMARY OF INVENTION

The present invention overcomes the limitations of conventional systems, using an architecture in which multiple network fingerprint sensors are connected to a network based on the TCP/IP (Transmission Control Protocol/Internet Protocol) protocol (or equivalent) suite. These network fingerprint sensors provide Internet connectivity to the fingerprint integrated circuit by providing a network communication medium based on the TCP/IP protocol. Because fingerprint sensor control, fingerprint sensor optimizations, fingerprint sensor data analysis, and fingerprint authentications and verifications are all performed at a remote centralized authentication server, the network fingerprint sensors eliminated the requirement of a physical connection to a computer, or its equivalent in semiconductor chips. The network fingerprint sensors also eliminated the requirement of local memory storage for a database of fingerprint templates for comparison matching. All of the requirements of fingerprint image control, fingerprint image optimization, fingerprint data analysis, fingerprint data storage, fingerprint template data storage, fingerprint authentication and verification have all been centralized at a single remote network connected server.

The network fingerprint sensor is comprised of a fingerprint sensor integrated circuit (IC) module, and a network communication integrated circuit (IC) module.

The purpose of the fingerprint sensor IC module is to capture a person's fingerprint image or template data. The sensor could use capacitive or other known sensing techniques. An example of a capacitive sensor is the Authentec AFS2 sensor available from Authentec, Inc. (FL, USA). This data is then transferred at 921.6 Kbit per second serially to the network communication IC module.

Alternatively, the fingerprint sensor data can also be transferred in parallel, or other serial methods to the network communication IC module.

The network communication IC module allows the centralized server to control, to optimize, to analyze, and to extract fingerprint data from the fingerprint sensor IC. The network communication IC module takes the high speed serial data from the fingerprint sensor IC module, encrypts the fingerprint data, and formats the encrypted fingerprint data to comply with the TCP/IP protocol, or equivalent suite.

The formatted packet is then transmitted to the network using Ethernet technologies (IEEE 802.3), or wireless technologies such as 802.11x, or BlueTooth.

The centralized server receives multiple fingerprint authentication requests from multiple network fingerprint sensors. The centralized server accepts the TCP/IP packets from the network fingerprint sensors. The server sends controls, optimization parameters, and commands to obtain the fingerprint data from the network fingerprint sensors. The server extracts the encrypted fingerprint image data from the TCP/IP packet. The encrypted fingerprint data is decrypted to obtain the fingerprint image, or fingerprint template data for analysis.

The centralized server then compares the received fingerprint data with its own internal fingerprint database to provide a fingerprint authentication, or verification result. The server formats the fingerprint authentication/verification result in TCP/IP (or equivalent) format and sends the packet via Ethernet, or wirelessly back to each network fingerprint sensor.

The network fingerprint sensor receives the fingerprint authentication, or verification result from the centralized authentication server via the network. It then extracts the authentication result from the formatted packet.

The network fingerprint sensor then executes appropriate functions depending on whether the received authentication result is positive or negative from the fingerprint authentication server.

### BRIEF DESCRIPTION OF DRAWINGS

FIG. 1 shows the overall architecture of a network fingerprint sensor authentication system according to the present invention.

FIG. 2 shows the overall architecture of a wireless network fingerprint sensor authentication system according to the present invention.

FIG. 3 is a block diagram showing a network fingerprint sensor in accordance with the invention.

FIG. 4 is a block diagram of a wireless network fingerprint sensor according to the present invention.

FIG. 5 is a flow chart showing the operation of a network fingerprint sensor according to the present invention.

FIG. 6 is a flow chart showing the operation of an authentication server according to the present invention.

FIG. 7 is a diagram showing the communication exchange between multiple network fingerprint sensors and the authentication server according to the present invention.

### DETAILED DESCRIPTION

In the following detailed description of the embodiments, reference is made to the accompanying drawings which form a part hereof, and in which there is shown by way of illustration particular example of the invention. It will be understood that other embodiments may be utilized and structural changes may be made without departing from the scope of the present invention.

[General Architecture and Method]

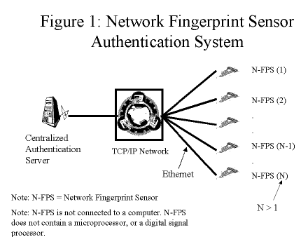

FIG. 1 depicts a general topology of a network fingerprint sensor authentication system according to the invention. In particular, FIG. 1 shows 3 major components of the system:

a) a centralized authentication server which is capable of simultaneously control, optimize, obtain fingerprint data, analyze fingerprint data, and authenticate and verify fingerprints from multiple remote network connected fingerprint sensors,

b) multiple remote network connected fingerprint sensors (network fingerprint sensors), and

c) a communication network based on the Transmission Control Protocol/Internet Protocol (TCP/IP) (or equivalent protocols).

For the centralized authentication server depicted in FIG. 1, the assumption is that appropriate networking hardware is present to establish a secure, reliable, and high speed communication environment. These networking hardware may include but not limited to routers, switches, hubs, firewalls, etc.

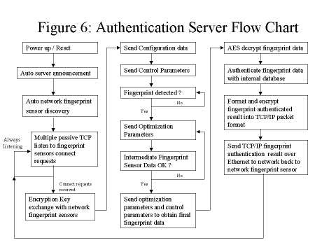

Referring now to FIGS. 1, 6 and 7, it will be seen that upon power up, or reset, the authentication server advertises itself by using “Broadcast over UDP (User Datagram Protocol),” and/or “Multicast over UDP”, and/or UDP.

The authentication server then searches for network fingerprint sensors by listening on “Broadcast over UDP”, and/or “Multicast over UDP”, and/or UDP.

The authentication server is then listening for TCP (Transmission Control Protocol) connect requests from all ports for multiple remote network connected fingerprint sensors.

Once TCP connect requests are received from network fingerprint sensors, the authentication server establishes a unique TCP connection with each network fingerprint sensor.

The authentication server then initiates a sequence of events to exchange unique secret encryption key with each network fingerprint sensor.

The authentication server sends to the network fingerprint sensors configuration parameters to determine the type of fingerprint integrated circuit chips that are residing in the various types of network fingerprint sensors.

Once the fingerprint integrated circuit chips are identified at the network fingerprint sensors, the authentication server sends control and optimization parameters to the network fingerprint sensors to collect any available fingerprint image data, or fingerprint template data for analysis.

When the authentication server receives the encrypted fingerprint data, it decrypts the data to extract the fingerprint image data, or the fingerprint template data.

The authentication server will repeatedly sends control and optimization parameters to the network fingerprint sensors to obtain fingerprint data for analysis until it is satisfied with the quality of the fingerprint data.

Once the authentication server has the final fingerprint data, its main task is to simultaneously authenticate and verify fingerprints from multiple remote network connected fingerprint sensors. The authentication server uses the fingerprint image data, or the fingerprint template data, and compares the received fingerprint data with its internal fingerprint database for comparison matching.

After the fingerprint authentication matching is completed, the authentication server sends the fingerprint authentication comparison results back to the network fingerprint sensors.

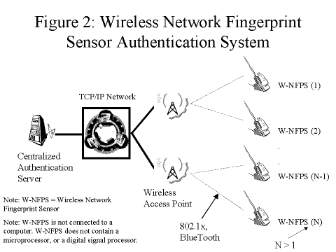

Referring now to FIG. 2, there is shown further detail of a wireless network fingerprint sensor authentication system according to the invention. In particular, FIG. 2 shows four major components of the system:

a) a centralized authentication server which is capable of simultaneously control, optimize, obtain fingerprint data, analyze fingerprint data, authenticate and verify fingerprints from multiple remote wireless network connected fingerprint sensors,

b) multiple remote wireless network connected fingerprint sensors (wireless network fingerprint sensors),

c) wireless access points which provide a network communication medium between the wireless network fingerprint sensors and the TCP/IP network, and

d) a communication network based on the Transmission Control Protocol/Internet Protocol (TCP/IP) (or equivalent protocols).

[Subsystems]

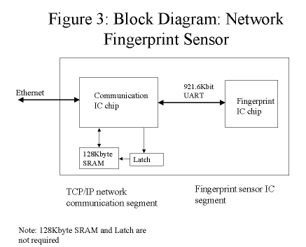

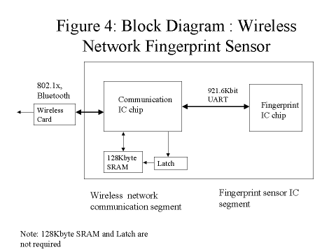

We next refer to FIGS. 3 and 4. The following description uses the network fingerprint sensor as an example. However, substantially all description that applies to the network fingerprint sensor also applies to the wireless network fingerprint sensors depicted in FIG. 4.

As shown in FIG. 3, a key attribute of the network fingerprint sensor is that it need not be (and in fact, as shown in FIG. 3, is not) physically connected directly to a computer, and it need not contain a microprocessor or a digital signal processor.

As depicted in FIG. 3, the network fingerprint sensor is comprised of 2 subsystems. The first is the fingerprint subsystem, and the second is the communication subsystem.

The main task of the fingerprint subsystem in FIG. 3 is to collect the fingerprint image data and the fingerprint template data and transmit the data in a serial bit stream to the communication subsystem. In the illustrated examples, the fingerprint subsystem transmits the data at 921.6 Kbit per second using the Universal Asynchronous Receiver Transmitter (UART) protocol at 8 data bits, no parity, 1 stop bit. Other transmission schemes may be used equivalently.

The fingerprint subsystem also receives configuration parameters from the centralized authentication server via the communication subsystem to initialize and to control the fingerprint sensor integrated circuit when power is applied, or during a reset of the entire subsystem. The fingerprint subsystem receives data at 921.6 Kbit per second using the Universal Asynchronous Receiver Transmitter (UART) protocol at 8 data bits, no parity, 1 stop bit.

During normal operation, the fingerprint subsystem also receives control and optimization parameters from the centralized authentication server via the communication subsystem to optimize the fingerprint capture mechanism in the fingerprint sensor integrated circuit. The communication mode is again a UART at 921.6 Kbit per second at 8 data bits, no parity, 1 stop bit. Other communication schemes may be used equivalently.

A function of the communication subsystem in FIG. 3 is to provide an Ethernet to serial bridge communication channel between the TCP/IP (Transmission Control Protocol/Internet Protocol) network and the fingerprint sensor subsystem. In the illustrated embodiments, the communication subsystem can be implemented in a single chip. By way of example, the communication integrated chip (IC) can be a commercially available RISC processor offered by Ubicom, Inc. of Mountain View, Calif., part number IP2022. The communication IC chip in the communication subsystem provides for the following functions:

a. 1 OMbit (IEEE 802.3) Ethernet to 921.6 Kbit per second serial (UART) bridge communication channel

b. 100% RFC (Request For Comments) compliant TCP/IP (Transmission Control Protocol/Internet Protocol) stack

c. Auto IP: On power-up, or on reset, the communication subsystem will automatically search for a DHCP (Dynamic Host Configuration Protocol) server to request an IP (Internet Protocol) address. If no DHCP server is discovered, the communication subsystem automatically assigns itself an IP address based on the network environment

d. Auto IP Override: During normal operations, the communication subsystem provides a mechanism in which the authentication server, or a person with secure network access, to alter the IP address, the subnet mask the default gateway IP address, and a customizable name of the communication subsystem.

e. Auto Authentication Server Discovery: On power-up, or on reset, the communication subsystem will use Broadcast over UDP (User Datagram Protocol), or Multicast over UDP or proprietary protocol over UDP to discover the IP address of the authentication server ef. Auto Discovery: the communication subsystem will use Broadcast over UDP (User Datagram Protocol), or Multicast over UDP or proprietary protocol over UDP to discover other network enabled devices to create a virtual community.

f. AES (Advanced Encryption Standard) encryption for transmitting fingerprint image data, or fingerprint template data.

g. Symmetric key exchange for AES encryption.

h. Self-destruct mechanism: To insure the physical security of the network fingerprint sensor, the communication subsystem has the ability to detect when the network fingerprint sensor is in an unknown network environment. 1. Once an unknown network environment is detected, the communication subsystem requests “help advice” from both the authentication server and other network fingerprint sensors that have been recorded in the communication subsystem's history log. 2. If the communication subsystem cannot verify the authenticity of the “help advice” from both the authentication server and the other network fingerprint sensors, the communication subsystem will initiate the self-destruct mechanism. 3. Once the self-destruct mechanism is triggered the communication subsystem will automatically corrupt its internal software code, thus destroying itself. The communication subsystem will then be in a “dead” state which is not recoverable.

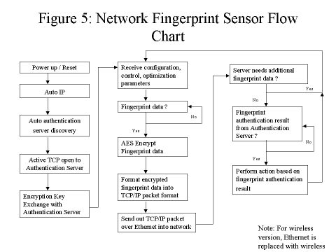

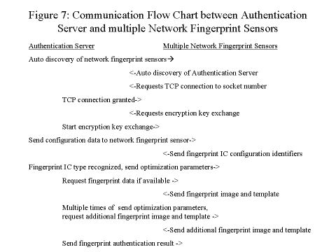

As depicted in FIG. 5 and FIG. 7, on power up, or reset, the network fingerprint sensor as depicted in FIG. 3 initiates “Auto IP” to determine its own IP address. If no DHCP server is found, the network fingerprint sensor will assign itself an IP address based on its network environment.

The network fingerprint sensor then initiates “Auto Server Discovery” to obtain the IP address of the authentication server.

Once the IP address of the authentication server is obtained, the network fingerprint sensor then initiates a request to establish a TCP communication channel with the authentication server.

Once the TCP communication channel with the authentication server is established, a sequence of events occurred in which secret encryption keys are exchanged between the network fingerprint sensor and the authentication server.

Once the secret encryption key exchange is completed, the network fingerprint sensor is in receive mode for configuration parameters.

Once the configuration parameters are received from the authentication server, the network fingerprint sensor responds back to the authentication server with configuration data that is specific to the fingerprint IC chip that is in the network fingerprint sensor.

The network fingerprint sensor is then in ready mode to send data when there is a fingerprint on the fingerprint IC chip.

Once the centralized authentication server detects a fingerprint at a particular network fingerprint sensor, it sends optimization parameters to the network fingerprint sensor to obtain intermediate fingerprint data. After analyzing the intermediate fingerprint data from the network fingerprint sensor over a period of time, the centralized authentication server sends control and optimization parameters to the network fingerprint sensor to obtain the final fingerprint data.

The network fingerprint sensor receives the fingerprint data, it encrypts the fingerprint data with AES and formats it in a TCP/IP packet format.

Once a read command is issued by the authentication server, the network fingerprint sensor sends the encrypted fingerprint data in the TCP/IP format to the authentication server for fingerprint authentication and verification.

The network fingerprint sensor waits for the result from the authentication server. If the authentication server result is positive on the fingerprint matching, the network fingerprint sensor performs a set of positive tasks. If the authentication server result is negative on the fingerprint matching, the network fingerprint sensor performs a set of negative tasks.

After performing the tasks based on the result of the fingerprint matching from the authentication server, the network fingerprint sensor is in ready mode to send new fingerprint data to the authentication server.

[TCP/IP]

A communication network based on the TCP/IP (Transmission Control Protocol/Internet Protocol), which is a protocol suite used in one practice of the invention, contains the following protocols:

IP/IPv6—Internet Protocol.

TCP—Transmission Control Protocol.

UDP—User Datagram Protocol.

Data Link Layer

ARP/RARP—Address Resolution Protocol/Reverse Address.

DCAP—Data Link Switching Client Access Protocol.

Tunneling Protocols

L2TP—Layer 2 Tunneling Protocol.

Network Layer

DHCP—Dynamic Host Configuration Protocol.

ICMP/ICMPv6—Internet Control Message Protocol.

IGMP—Internet Group Management Protocol.

MARS—Multicast Address Resolution Server.

PIM—Protocol Independent Multicast-Sparse Mode (PIM-SM).

RIP2—Routing Information Protocol.

RIPng for IPv6.

RSVP—Resource ReSerVation setup Protocol.

VRRP—Virtual Router Redundancy Protocol.

Security

AH—Authentication Header.

ESP—Encapsulating Security Payload.

Routing

BGP-4—Border Gateway Protocol.

EGP—Exterior Gateway Protocol.

HSRP—Cisco Hot Standby Router Protocol.

IGRP—Interior Gateway Routing.

NARP—NBMA Address Resolution Protocol.

NHRP—Next Hop Resolution Protocol.

OSPF—Open Shortest Path First.

Transport Layer

RUDP—Reliable UDP.

TALI—Transport Adapter Layer Interface.

Van Jacobson—compressed TCP.

XOT—X.25 over TCP.

Although the invention has been described by way of embodiments utilizing TCP/IP protocols, other network communications protocols can be used equivalently.

The present invention has been described in detail in connection with the examples and embodiments set forth above. It will be understood by those skilled in the art that the present disclosure of embodiments has been made by way of example only and that numerous changes in the arrangement and combination of parts as well as steps may be resorted to without departing from the spirit and scope of the invention.

What is claimed is:

1. A network fingerprint authentication system which comprising: a) multiple, remote, network connected network fingerprint sensors, b) a centralized server farm, operable to communicate with the network fingerprint sensors, and including a plurality of computer servers, each of which can simultaneously control, optimize, obtain fingerprint data, analyze fingerprint data, authenticate and verify the identities of the fingerprints for multiple remote network connected fingerprint sensors, and c) a communication network utilizing the TCP/IP (Transmission Control Protocol/Internet Protocol) protocol suite utilized by elements (a) and (b) above for communication.

2. The system of claim 1 wherein the communication network can also be a wireless network protocol such as 802.11×, or BlueTooth.

3. The system of claim 1 wherein the network fingerprint sensors rely on the centralized server for functional operations.

4. The system of claim 1 wherein the network fingerprint sensor is comprised of a fingerprint capture subsystem and a network communication subsystem.

5. The system of claim 1 wherein the network fingerprint sensors include elements for performing a serial or parallel to Ethernet (IEEE 802.3), or wireless bridging function.

6. The system of claim 1 in which there is no physical connection to a computer.

7. The system of claim 1 in which the network fingerprint sensor captures fingerprint data and sends it to the authentication server via a network.
